(19) United States
(12) Patent Application Publication
(10) Pub. No.: US 2015/0377354 A1
(43) Pub. Date: Dec. 31, 2015

(54) NOZZLE SEALING STRUCTURE FOR METAL GAS PIPES

(71) Applicant: SEVEN UNIVERSE INDUSTRIAL CO., LTD., TAICHUNG CITY (TW)

(72) Inventors: Pao-Chi CHANG, TAICHUNG CITY (TW); Chin-Chu LIU, TAICHUNG CITY (TW)

(21) Appl. No.: 14/315,811

(22) Filed: Jun. 26, 2014

(51) Int. Cl. F16J 15/02

(52) U.S. Cl. CPC F16J 15/022

(57) ABSTRACT

The present invention provides a nozzle sealing structure for metal gas pipes, which comprises a metal gas pipe and a seal. The seal is to cover the nozzle of the metal gas pipe, and has appropriate elasticity. Its outer side is configured with a conical surface. The seal is elastically fixed inside the nozzle of the metal gas pipe through the conical surface. The structure features easy assembly, perfect sealing, no pollution to the environment, and no harm to human health.

### BACKGROUND OF INVENTION

1. Field of the Invention

The present invention relates generally to gas equipment, and more particularly to a nozzle sealing structure for metal gas pipes which offers perfect sealing to guarantee product quality.

2. Description of Related Art

Metal gas pipes are a component for transporting gas to gas equipment (gas stove, gas oven, etc) used by families or restaurants. The pipe body must be completely sealed to avoid dangers of gas leakage. Hence, the sealing quality is very important.

Conventional metal gas pipe sealing techniques include: sealing the nozzle with a seal and welding it; combining a seal with a rubber ring and a pressing rivet; and plugging of a metal ball. Products with a nozzle seal and welding must adopt anti-oxidation treatment (electroplating or painting) to prevent rust of the welding point. The welding process will generate high temperature, strong light and toxic gas, which are harmful to the health of workers. Poor welding of unskilled workers will lead to gas leakage or even outright product failure. Anti-oxidation processes will also affect the health of workers and cause pollution to the environment. For example, the electroplating solution is a serious pollutant, and the paint will cause injury of the respiratory apparatus of workers. In the case of combining a seal with a rubber ring and a pressing rivet, although the sealing is good, the rubber ring is not well resistant to high temperatures and may become deteriorated after a period of usage and consequently affect the sealing. In the last case, plugging a metal ball to seal the metal gas pipe may burst the metal gas pipe, or cause breakage of the metal gas pipe and leakage after a long period of use under stress.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The main objective of the present invention is to provide a nozzle sealing structure for metal gas pipes, which adopts cold processing technology and can reliably seal the metal gas pipe, and which can effectively overcome the disadvantages of the above-stated techniques of welding, combination of rubber ring and pressing rivet, and plugging of a metal ball, so that the product quality can be ensured and operational safety enhanced.

To realize the above objective, the present invention provides a nozzle sealing structure for metal gas pipes, which comprises a metal gas pipe and a seal. The seal covers the nozzle of the metal gas pipe; it is characterized in that: the seal has appropriate elasticity, its outside is provided with a conical surface, and the seal is fixed inside the nozzle with the conical surface.

### BRIEF DESCRIPTION OF THE DRAWINGS

The present invention will be more readily understood upon a thoughtful deliberation of the following detailed description of two preferred embodiments of the present invention with reference to the accompanying drawings, wherein:

FIG. 1 is a schematic diagram of a first preferred embodiment of the present invention;

FIG. 2 is a partial sectional view of the first preferred embodiment of the present invention;

FIG. 3 is an exploded view of a second preferred embodiment of the present invention.

### DETAILED DESCRIPTION OF THE INVENTION

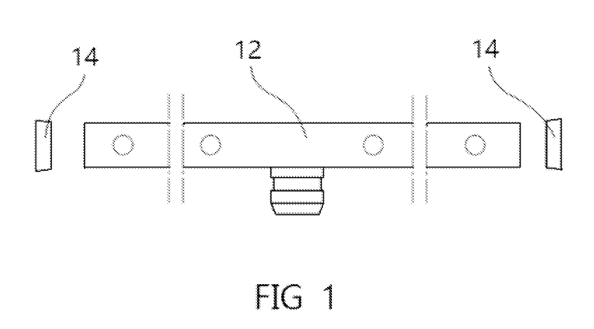

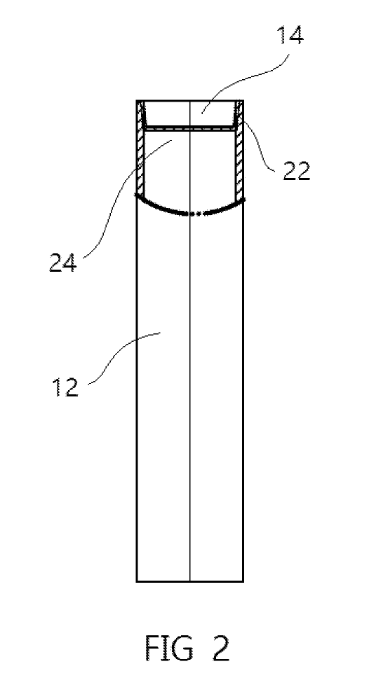

Firstly, FIG. 1 and FIG. 2 show the nozzle sealing structure for metal gas pipes, as a preferred embodiment of the present invention, which comprises a metal gas pipe 12 and a seal 14.

The metal gas pipe 12 is used to transport gas as fuel for the functioning of special equipment (e.g. gas stove, gas oven etc).

The seal 14 is made of metallic material or composite material with appropriate elasticity. Its thickness is less than the wall thickness of the metal gas pipe 12, and it is roughly in the shape of a cone disc, so as to form a conical surface 22 on its outer side. The conical surface 22 is used to fix the seal tightly inside the nozzle 24 of the metal gas pipe 12. In actual operation to fix the two, the lower end of the seal 14 (small-head end) is firstly plugged into the nozzle 24 of the metal gas pipe 12, a fixture is used in company with pneumatic or hydraulic tools or equipment to press the upper end (large-head end) of the seal 14, so as to plug the seal 14 into the nozzle 24 of the metal gas pipe 12, till the seal 14 is completely buried into the nozzle 24 of the metal gas pipe 12 and reaches a certain distance inside. In this way, as the seal 14 is made of metallic material or composite material with appropriate elasticity, its elastic tension can generate sufficient friction and tightening force to be plugged inside the nozzle 24 of the metal gas pipe 12.

Thereby, the present invention of a nozzle sealing structure for metal gas pipes has the following characteristics and efficacies:

Through tight fitting between the conical surface 22 of the seal 14 and the nozzle 24 of the metal gas pipe 12, the present invention can reliably seal the metal gas pipe 12. Being a cold processing technique without the need of welding, it can not only maintain integrity of the shape of the metal gas pipe 12, but also protect workers from harms of toxic gas and high temperatures resulting from the welding process.

Secondly, as the seal 14 has appropriate elasticity, when it is plugged into the nozzle 24 of the metal gas pipe 12, it can generate an elastic tension to be fixed on the inner wall of the nozzle 24 of the metal gas pipe 12. Therefore, the sealing of the metal gas pipe 12 can be guaranteed, and the height of the seal 14 can prevent it from fall-off.

In addition, as the thickness of the seal 14 is less than the wall thickness of the metal gas pipe 12, when it is plugged into the metal gas pipe 12, it will not cause deformation of the nozzle 24. Hence, it can maintain integrity of the shape of the metal gas pipe 12, and ensure product quality.

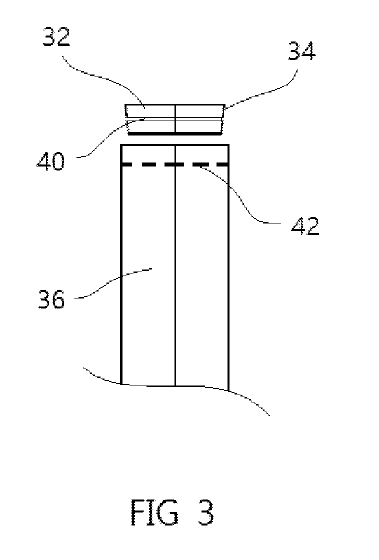

FIG. 3 depicts the nozzle sealing structure for metal gas pipes as another preferred embodiment of the present invention. Its components are roughly the same as the previously disclosed embodiment. Difference lies in that: the inner sides of the conical surface 34 of the seal 32 and the nozzle 24 of the metal gas pipe 36 are correspondingly configured with a first clamping portion 40 and a second clamping portion 42 that can relatively clamp with each other, in the form of a ring-shaped concave and convex. Thereby, through the corresponding clamping between the first and second clamping portions 40, 42, the fixing stability and sealing between the seal 32 and metal gas pipe 36 can be further enhanced.

It is to be noted that, the first clamping portion of the seal and the second clamping portion of the metal gas pipe are not limited to the above-disclosed type. As long as the two can correspondingly clamp or abut to prevent the seal from falling off the nozzle of the metal gas pipe, the requirement of the present invention is met, and the type falls within the technical scope of the present invention, for example, clamping between a plurality of convex points and a groove or abutting between a convex ring and a plurality of convex points etc.

To summarize, the nozzle sealing structure for metal gas pipes disclosed the present invention does not need gluing or welding. Through the cold processing technology that the seal is tightly plugged into the nozzle of the metal gas pipe, the invention can reliably guarantee the sealing of the metal gas pipe, and can overcome the technical disadvantages of conventional techniques of welding, combination of rubber ring and pressing rivet, and plugging of a metal ball. Moreover, it can maintain the integrity of the shape of the metal gas pipe, ensure product quality and enhance safety of use. It is indeed an invention of practical value.

1. A nozzle sealing structure for metal gas pipes, comprising a metal gas pipe and a seal; the seal is to cover the nozzle of the metal gas pipe; it is characterized in that: the seal has appropriate elasticity, with its outer side configured with a conical surface; the seal is elastically fixed inside the nozzle of the metal gas pipe through the conical surface.

2. The structure defined in claim 1, wherein the section of the seal is in the shape of a cone disc along the axis of the metal gas pipe, so as to form a conical surface on its outer side.

3. The structure defined in claim 2, wherein the seal is tightly plugged into the nozzle of the metal gas pipe.

4. The structure defined in claim 2, wherein the inner sides of the conical surface and the nozzle of the metal gas pipe are correspondingly configured with a first clamping portion and a second clamping portion that can relatively clamp with each other.

5. The structure defined in claim 4, wherein the first and second clamping portions are a concave and a convex that can clamp with each other.

6. The structure defined in claim 3, wherein the thickness of the seal is less than the wall thickness of the metal gas pipe.

7. The structure defined in claim 4, wherein the seal is made of metallic material or composite material with elasticity.

8. The structure defined in claim 3, wherein the seal is made of metallic material or composite material with elasticity.

9. The structure defined in claim 4, wherein the seal is made of metallic material or composite material with elasticity.
